(19) United States
(12) Patent Application Publication
(10) Pub. No.: US 2014/0163917 A1
(43) Pub. Date: Jun. 12, 2014

(54) MULTI-SENSING-ELEMENTS CALIBRATION SYSTEM, MULTI-SENSING-ELEMENTS CALIBRATION METHOD AND RECORDING MEDIUM

(71) Applicant: INSTITUTE FOR INFORMATION INDUSTRY, Taipei City (TW)

(72) Inventors: Po-Cheng HUANG, Sihu Township (TW); Ming-Cheng LIN, Kaohsiung City (TW); Chin-Shun HSU, Kaohsiung City (TW)

(21) Appl. No.: 13/900,056

(22) Filed: May 22, 2013

(30) Foreign Application Priority Data
Dec. 7, 2012 (TW) 101146068

(51) Int. Cl. G01D 18/00

(52) U.S. Cl. CPC G01D 18/00
USPC 702/104

(57) ABSTRACT

A multi-sensing-elements sensing calibration system, a multi-sensing-elements sensing calibration method and a recording medium are provided. This system includes a plurality of sensing elements, a first calculating module and a second calculating module. The sensing elements are configured at a same place and generate corresponding sensing values under a plurality of sensing conditions. The first calculating module generates a plurality of corresponding average values from the sensing values under the sensing conditions. The second calculating module generates a corresponding calibration curve according to sensing values of each sensing element under a plurality of sensing conditions and each average value, and the calibration curve is provided to correct each sensing element.

### CROSS-REFERENCE TO RELATED APPLICATION

This application claims the benefit of Taiwan Patent Application No. 101146068, filed on Dec. 7, 2012, which is hereby incorporated by reference for all purposes as if fully set forth herein.

### BACKGROUND OF THE INVENTION

1. Field of Invention

The present invention relates to a sensing element calibration system, a sensing element calibration method and a recording medium, and more particularly to a calibration system, a calibration method and a recording medium in which a plurality of sensing elements configured at a same place is corrected under a plurality of sensing conditions.

2. Related Art

In the prior art, a sensing system includes more than one sensing element, and the sensing elements are distributed at different sites of an environment, and used for sensing a whole variation situation of the environment. However, before the sensing elements are configured, the sensing elements need to be adjusted for sensing calibration. Generally a standard sensing element is used, and a sensing value of each sensing element is compared with a sensing value of the standard sensing element to establish a calibration curve for many sensing elements. Sometimes, a calibration value of each sensing element is found through a difference between a sensing value of the sensing element and that of the sensing calibration element to establish a calibration curve for each sensing element in several sensing conditions respectively. Alternatively, under a premise of obtaining a known calibration parameter, each sensing element is directly corrected with this calibration parameter. However, if one of the sensing calibration element, the sensing value of the sensing calibration element, and the calibration parameter is lost, the sensing elements of the sensing system cannot be corrected.

### SUMMARY OF THE INVENTION

The present invention aims to provide a multi-sensing-elements calibration system, a multi-sensing-elements calibration method and a recording medium, so that a plurality of sensing elements can be directly used to perform sensing calibration without the calibration curve generated by the standard sensing calibration elements or calibration parameters. In the present invention, a plurality of calibration values may be obtained under a plurality of sensing conditions, and a calibration curve of each sensing element is generated.

The multi-sensing-elements calibration system disclosed in the present invention comprises a plurality of sensing elements, a first calculating module and a second calculating module.

The sensing elements are configured at a same place, and each sensing element is separately used for generating a first sensing value under a first sensing condition, generating a second sensing value under a second sensing condition, and generating a third sensing value under a third sensing condition. The first calculating module is configured for obtaining a first average value according to the first sensing values generated by the sensing elements under the first sensing condition, obtaining a second average value according to the second sensing values generated by the sensing elements under the second sensing condition, and obtaining a third average value according to the third sensing values generated by the sensing elements under the third sensing condition.

The second calculating module is configured for generating a calibration curve for each sensing element according to the first sensing value, the second sensing value, and the third sensing value of each sensing element, the first average value, the second average value and the third average value. The multi-sensing-elements calibration method disclosed in the present invention comprises: providing, by a plurality of sensing elements, a plurality of sensing values, wherein the sensing elements are configured at a same place, and each sensing element is separately used for generating a first sensing value under a first sensing condition, generating a second sensing value under a second sensing condition, and generating a third sensing value under a third sensing condition; obtaining, by a first calculating module, a first average value according to the first sensing values generated by the sensing elements under the first sensing condition; obtaining a second average value according to second sensing values generated by the sensing elements under the second sensing condition, and obtaining a third average value according to third sensing values generated by the sensing elements under the third sensing condition; and generating, by a second calculating module, a calibration curve for each sensing element according to the first sensing value, the second sensing value, and the third sensing value of each sensing element, the first average value, the second average value and the third average value.

The present invention has also disclosed a non-immediately recording medium, storing a program code readable by an electronic apparatus, wherein when the electronic apparatus reads the program code, a multi-sensing-elements calibration method is executed. This method is as described above, and is not repeated herein.

In the present invention, an appropriate calibration curve is found for each sensing element to separately correct each sensing element by the plurality of sensing elements of the system. It means that the sensing calibration element is not needed and the practicability of the sensing system is promoted. Secondly, the technology disclosed in the present invention can be integrated with the existing sensing system without substantially changing the structure of the existing sensing system, thereby promoting applicability of the sensing system.

### BRIEF DESCRIPTION OF THE DRAWINGS

The present invention will become more fully understood from the detailed description given herein below for illustration only, and thus are not limitative of the present invention, and in which:

FIG. 1 is a schematic diagram of a first architecture of a sensing system of an embodiment of the present invention;

FIG. 2A is a schematic data transmission diagram of the first architecture of the sensing system of the embodiment of the present invention;

FIG. 2B is another schematic data transmission diagram of the first architecture of the sensing system of the embodiment of the present invention;

FIG. 3 is a schematic diagram of a second architecture of the sensing system of the embodiment of the present invention; and

FIG. 4 is a schematic diagram of a calibration flow of a multi-sensing-elements sensing system of an embodiment of the present invention.

### DETAILED DESCRIPTION OF THE INVENTION

Preferred embodiments of the present invention are described in detail below with reference to the accompanying drawings.

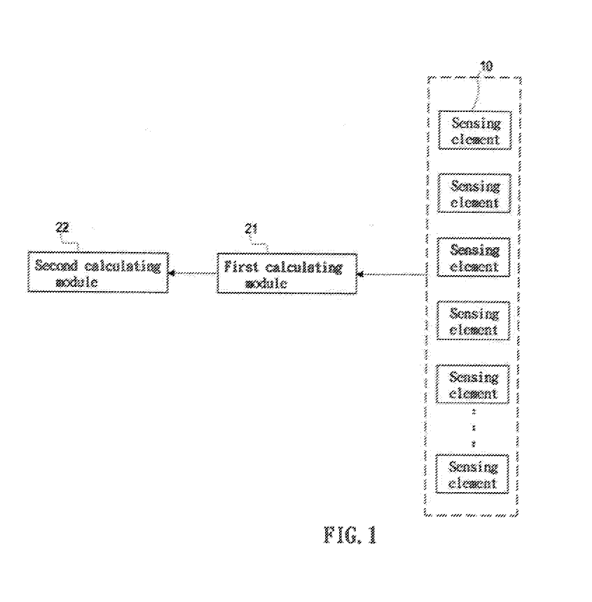

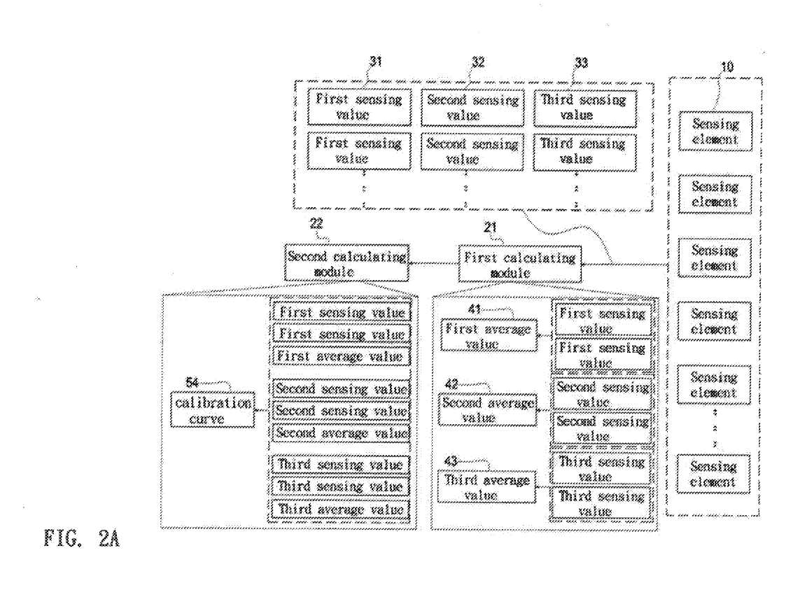

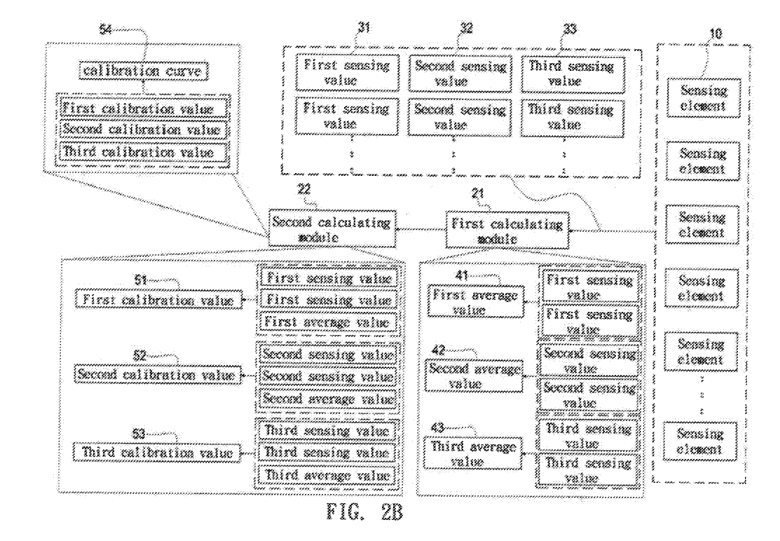

FIG. 1 is a schematic diagram of a first architecture of a sensing system of an embodiment of the present invention and FIG. 2A is a schematic data transmission diagram of the first architecture of the sensing system of the embodiment of the present invention. This system includes a plurality of sensing elements 10, a first calculating module 21 and a second calculating module 22. Each of the calculating modules may be a processor, a chip, an integrated circuit, or hardware having an operational capability such as an operational circuit, an apparatus, a component and a device. Furthermore, it may be a software with particular hardware such as a program in an operational system, in chips or in integrated circuits. The first calculating module 21 and the second calculating module 22 may be respectively disposed at different hardware. In some embodiments, the two calculating modules may also be integrated by a hardware in cooperation with software. At the time of performing calibration, the plurality of sensing elements 10 must be sensing elements of a same specification and type, but the specification and the type of the sensing elements are not limited.

The sensing elements 10 are configured at a same place. It means that, the sensing elements 10 are placed at the same position or location, simultaneously or in batches for measurement. Alternatively, all the sensing elements 10 are adjacently configured at a place within an interval range. The interval range may differ according to an actual specification of different sensing elements or according to the actual experiences. The configuration manner depends on demands of a tester, and is not limited.

The sensing elements 10 are separately sensed under different sensing conditions. The sensing condition differs in dependence on the type of the sensing elements 10. For example, if the type of the sensing elements 10 is temperature sensing, each sensing condition is corresponding to a different environment temperature. If the type of the sensing elements 10 is humidity sensing, each sensing condition is corresponding to a different environment humidity. If the type of the sensing elements 10 is illuminance sensing, each sensing condition is corresponding to a different environment illuminance. It is not limited to. Alternatively, each sensing condition is corresponding to a different sensing time point. For example, these sensing elements 10 perform sensing at several sensing time points within a range of a sensing condition, so as to obtain a first sensing value 31, a second sensing value 32 and a third sensing value 33. Setting of a sensing condition may depend on demands of a designer or tester, or may depend on a sensing condition required for a general calibration curve, and is not limited. The number of sensing conditions may also depend on demands or requirements of a calibration curve, and is generally at least more than three. The larger the number is, the more precise the calibration curve may be.

In this embodiment, there are three sensing conditions, which are respectively a first sensing condition, a second sensing condition and a third sensing condition. A sensing value generated by each sensing element 10 under the first sensing condition is the first sensing value 31, a sensing value generated by each sensing element 10 under the second sensing condition is the second sensing value 32, and a sensing value generated by each sensing element 10 under the third sensing condition is the third sensing value 33.

The first calculating module 21 obtains first sensing values 31, second sensing values 32 and third sensing values 33 provided by all the sensing elements 10. The first calculating module 21 obtains a first average value 41 according to all the first sensing values 31, obtains a second average value 42 according to all the second sensing values 32, and obtains a third average value 43 according to all the third sensing values 33.

The second calculating module 22 obtains all of the first sensing values 31, the second sensing values 32, the third sensing values 33, the first average value 41, the second average value 42 and the third average value 43. Then, the second calculating module 22 may generate a calibration curve 54 for each sensing element 10 according to the first sensing value 31, the second sensing value 32, and the third sensing value 33 of each sensing element 10, the first average value 41, the second average value 42 and the third average value 43. The calibration curve 54 refers to a curve obtained from average values of all the sensing elements 10 corresponding to actual values of each sensing element 10 under different sensing conditions, that is to say, an axis X of the calibration curve 54 may be average values of all the sensing elements under different sensing conditions, and an axis Y thereof may be sensing values of each sensing element under different sensing conditions.

FIG. 2B is another schematic data transmission diagram of the first architecture of the sensing system of the embodiment of the present invention. In some other embodiments, the second calculating module 22 may calculate a first calibration value 51 for the first sensing condition separately according to the first sensing value 31 and the first average value 41 of each sensing element 10. The second calculating module 22 calculate a second calibration value 52 for the second sensing condition according to all the second sensing values 32 and the second average value 42. The second calculating module 22 calculates a third calibration value 53 for the third sensing condition according to all the third sensing values 33 and the third average value 43. For example, a calibration value may be a difference between a sensing value and an average value. Then, the second calculating module 22 may also generate a calibration curve for each sensing element according to the first calibration value 51, the second calibration value 52 and the third calibration value 53 of each sensing element, the first average value 41, the second average value 42 and the third average value 43. The calibration curve here slightly differs from that in the foregoing embodiment, an axis X thereof is average values of all the sensing elements 10 under different sensing conditions, and an axis Y thereof is calibration values of each sensing element 10 under different sensing conditions.

In other embodiments, the first calculating module 21 first averages all the first sensing values 31, so as to find a first estimated value. Then, the first calculating module 21 performs a difference calculated for all the first sensing values 31 and the first estimated value. The first sensing values 31, whose difference with the first estimated value exceeds a first threshold value, are eliminated, and then the remaining first sensing values 31 are calculated in order to obtain the first average value 41. That is to say, a sensing value which has a difference exceeding the first threshold value in the first sensing values 31 may be an error, and it should not be included when the first average value 41 is calculated, so that the first average value 41 is exempted from influence of the error. In a preferable embodiment, the first threshold value may be a double standard deviation calculated by the first calculating module 21 according to the first estimated value and all the first sensing values 31.

Much further, the sensing elements 10 with the first sensing values 31 whose difference with the first estimated value does not exceed the first threshold value are regarded as qualified sensing elements. With reference to the preceding embodiments, the second calculating module 22 may be used for generating a first calibration value 51, a second calibration value 52 and a third calibration value 53 for each sensing element 10 according to the first sensing value 31, the second sensing value 32, and the third sensing value 33 of each sensing element 10, the first average value 41, the second average value 42 and the third average value 43; and the second calculating module 22 may be used for generating a calibration curve 54 for each sensing element 10 according to the first calibration value 51, the second calibration value 52 and the third calibration value 53 of each sensing element 10, the first average value 41, the second average value 42 and the third average value 43. The calibration curve 54 may be used as a standard curve for correcting each sensing element 10.

In other embodiments, the sensing elements 10 with the first sensing values 31 whose difference with the first threshold value does not exceed the first threshold value are considered as qualified sensing elements, and the qualified sensing elements perform sensing according to the second sensing condition, and the first calculating module 21 obtains second sensing values 32, and then averages the second sensing values 32 to obtain a second estimated value. Next, the first calculating module 21 excludes sensing elements 10 with the second sensing values 32, where a difference between the second sensing values 32 and the second estimated value exceeds a second threshold value (such as a double standard deviation). This double standard deviation is calculated by the first calculating module 21 according to the second estimated value and the second sensing values 32. By the same token, the first calculating module 21 sets the sensing elements 10 remaining after secondary exclusion as the updated qualified sensing elements. Thay is say, sensing elements 10 with the first sensing values 31 and the second sensing values 32, in which the difference between the first sensing values 31 and the first estimated value does not exceed the first threshold value and the difference between the second sensing values 32 and the second estimated value does not exceed the second, are considered as qualified sensing elements. The qualified sensing elements remaining after the updating perform sensing according to the third sensing condition, so as to obtain third sensing values 33, and then the first calculating module 21 averages the third sensing values 33 to obtain a third estimated value, and excludes sensing elements 10 with the third sensing values 33, where a difference between the third sensing values 33 and the third estimated value exceeds a third threshold value (such as a double standard deviation). This double standard deviation is calculated by the first calculating module 21 according to the third estimated value and the third sensing values 33. The first calculating module 21 sets the sensing elements 10 remaining after tertiary exclusion as the updated qualified sensing elements. The first calculating module 21 regards sensing elements 10 with the first sensing values 31, the second sensing values 32 and the third sensing values 33, in which the difference between the first sensing values 31 and the first estimated value does not exceed the first threshold value, the difference between the second sensing values 32 and the second estimated value does not exceed the second threshold value, and the difference between the third sensing values 33 and the third estimated value does not exceed the third threshold value, are considered as qualified sensing elements remaining after the updating. The second calculating module 22 may generate a calibration curve for the qualified sensing elements according to the first sensing value 31, the second sensing value 32 and the third sensing value 33 (or the first calibration value 51, the second calibration value 52 and the third calibration value 53) for the qualified sensing elements remaining after the updating. However, the operational manner for the average value and the double standard deviation is obtained through a calculating manner of well-known general knowledge such as statistics, and is not described herein.

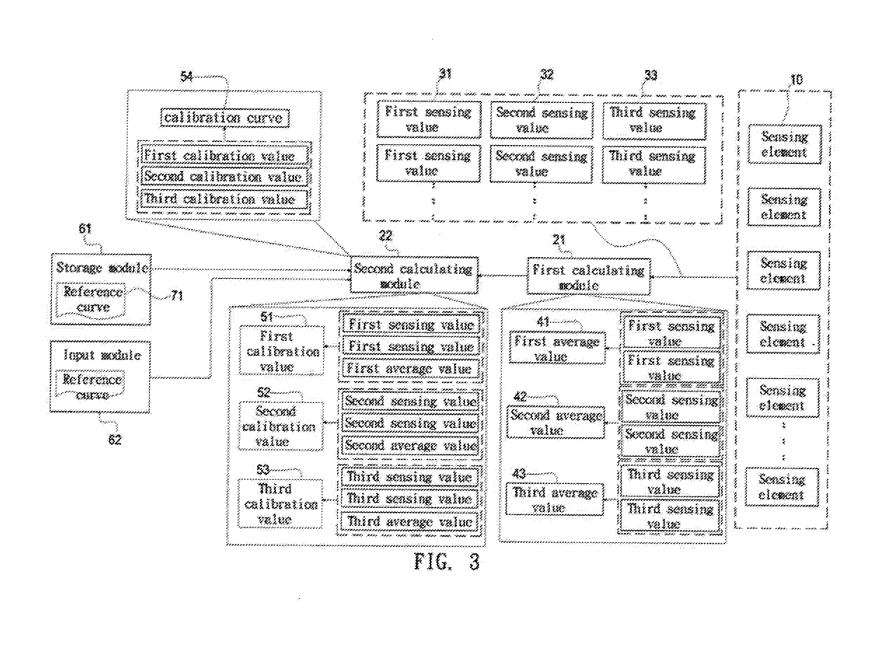

FIG. 3 is a schematic diagram of a second architecture of the system of the embodiment of the present invention. Different from the previous example, the system further includes an information providing module. This information providing module is used for providing a reference curve 71, and may be a storage module 61, which is provided to a second calculating module to perform reading. Alternatively, the information providing module may be an input module 62, which is be provided to a user or tester to perform inputting. The reference curve 71 may be generated according to a first sensing value 31, a second sensing value 32 and a third sensing value 33 of a standard sensing element under the first sensing condition, the second sensing condition and the third sensing condition, a first average value 41, a second average value 42 and a third average value 43.

Much further, this system includes a control interface. A user or tester may input a control instruction through this control interface, and the second calculating module 22, according to this control instruction, selects the reference curve 71 or the preceding calibration curve 54, which is provided to each sensing element 10 to perform a calibration operation.

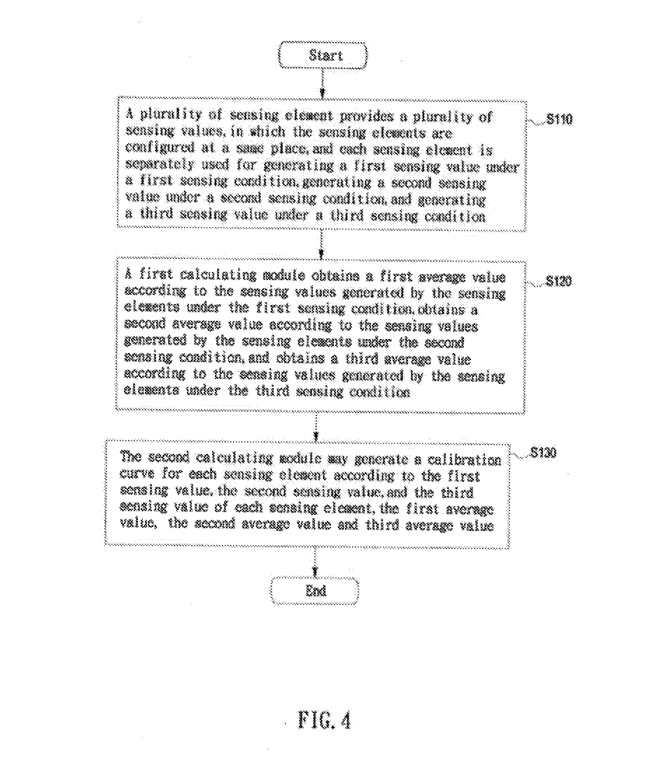

FIG. 4 is a schematic diagram of a calibration flow of multi-sensing-elements sensing system of an embodiment of the present invention, and better understanding is made with reference to FIG. 1 cooperatively. This flow includes the following steps.

A plurality of sensing elements 10 provides a plurality of sensing values, all the sensing elements 10 are configured at a same place, and each sensing element 10 is separately used for generating a corresponding sensing value under a first sensing condition, generating a corresponding sensing value under a second sensing condition, and generating a corresponding sensing value under a third sensing condition (step S110). In this step, each sensing element 10 generates a corresponding first sensing value 31 under the first sensing condition, generates a corresponding second sensing value 32 under the second sensing condition, and generates a corresponding third sensing value 33 under the third sensing condition. Each sensing condition is illustrated above, and is not described herein.

A first calculating module 21 obtains a first average value 41 according to the sensing values generated by the sensing elements 10 under the first sensing condition, obtains a second average value 42 according to the sensing values generated by the sensing elements 10 under the second sensing condition, and obtains a third average value 43 according to the sensing values generated by the sensing elements 10 under the third sensing condition (step S120). As described above, the first calculating module 21 obtains the first average value 41 according to the first sensing values 31, obtains the second average value 42 according to the second sensing values 32, and obtains the third average value 43 according to the third sensing values 33.

The second calculating module 22 may generate a calibration curve 54 for each sensing element according to the first sensing value 31, the second sensing value 32, and the third sensing value 33 of each sensing element 10, the first average value 41, the second average value 42 and the third average value 43 (step S130).

In the preceding step S120, much further, the first calculating module 21 regards sensing elements 10 with first sensing values 31, where a difference between the first sensing values 31 and a first estimated value does not exceed a first threshold value, as qualified sensing elements. The second calculating module 22, according to the first sensing value 31, the second sensing value 32 and the third sensing value 33 for each qualified sensing element, generates a calibration curve for the qualified sensing element, and the qualified sensing element is corrected through this calibration curve.

Alternatively, in the preceding step S120, the first calculating module 21, in a relevant step of obtaining average values, may regard sensing elements 10 with first sensing values 31, whose difference with the first estimated value does not exceed the first threshold value, as qualified sensing elements; the qualified sensing elements perform sensing according to the second sensing condition, and the first calculating module 21 averages the second sensing values 32 to obtain a second estimated value, excludes sensing elements 10 with the second sensing values 32, whose difference with the second estimated value dose not exceed a second threshold value, and regards the sensing elements remaining after the updating as qualified sensing element. The qualified sensing elements remaining after the updating perform sensing according to the third sensing condition, and the first calculating module 21 averages the third sensing values 33 to obtain a third estimated value, excludes sensing elements 10 with the third sensing values 33, whose difference with the third estimated value dose not exceeds a third threshold value, and regards the sensing elements remaining after the updating as qualified sensing element. Finally, the second calculating module 22 may generate a calibration curve for each qualified sensing element according to the first calibration value 51, the second calibration value 52 and the third calibration value 53 for each qualified sensing element remaining after the updating.

The method of the present invention may be implemented via the multi-sensing-elements sensing calibration system of the present invention, and each element in the system of the present invention may be implemented by use of a special hardware apparatus having a specific logic circuit or a device and an apparatus (such as sensing element) having a specific function, for example, a program code and a processor/chip are integrated into special hardware, or a program code and a commercially available specific device are integrated. Much further, the method of the present invention may also be implemented via a general-purpose processor/calculator/server and other hardware, and a part of elements (such as the first calculating module and the second calculating module) enable the general-purpose processor/calculator/server to read a non-immediately recording medium storing a program code before the method is executed. When the program code is loaded and executed by the general-purpose processor/calculator/server, this general-purpose processor/calculator/server becomes an element used for forming the system of the present invention, and is similar to a special hardware apparatus having a specific logic circuit, so as to execute the operating steps of the method of the present invention.

The present invention may further propose a non-immediately recording medium, and an electronic apparatus reads a program code stored in the preceding recording medium to execute the multi-sensing-elements calibration method, in which, the steps of the method are as described above, and are not described anymore.

To sum up, only implementation manners of technical solutions or the embodiments adopted by the present invention for solving the problems are recorded, and are not used to limit the patent implementation scope of the present invention. That is, all equivalent changes and modifications conforming to the meaning of the claims of the present invention or made according to the scope of the present invention fall within the scope of the present invention.

What is claimed is:

1. A multi-sensing-elements calibration system, comprising:
a plurality of sensing elements, configured at a same place, wherein each sensing element is separately used for generating a first sensing value under a first sensing condition, generating a second sensing value under a second sensing condition, and generating a third sensing value under a third sensing condition; and
a first calculating module, for obtaining a first average value according to the first sensing values generated by the sensing elements under the first sensing condition, obtaining a second average value according to the second sensing values generated by the sensing elements under the second sensing condition, and obtaining a third average value according to the third sensing values generated by the sensing elements under the third sensing condition; and
a second calculating module, for generating a calibration curve for each sensing element according to the first sensing value, the second sensing value, and the third sensing value of each sensing element, the first average value, the second average value and the third average value.

2. The multi-sensing-elements calibration system according to claim 1, wherein for the first calculating module obtaining the first average value according to the first sensing values generated by the sensing elements under the first sensing condition, the first calculating module generates a first estimated value by averaging the first sensing values, selects a plurality of specific first sensing values from the first sensing values, and obtains the first average value by averaging the plurality of specific first sensing values, wherein a difference between each of the plurality of specific first sensing values and the first estimated value does not exceed a threshold value.

3. The multi-sensing-elements calibration system according to claim 1, wherein the second calculating module is further used for generating a first calibration value, a second calibration value and a third calibration value for each sensing element according to the first sensing value, the second sensing value, and the third sensing value of each sensing element, the first average value, the second average value and the third average value; and the second calculating module generates a calibration curve for each sensing element according to the first calibration value, the second calibration value and the third calibration value of each sensing element, the first average value, the second average value and the third average value.

4. The multi-sensing-elements calibration system according to claim 2, wherein a sensing element with a sensing value, whose difference with the first estimated value does not exceed the threshold value, is a qualified sensing element, and the second calculating module generates a calibration curve for each qualified sensing element according to the first sensing value, the second sensing value, and the third sensing value of each qualified sensing element, the first average value, the second average value and the third average value, wherein the calibration curve of each qualified sensing element is provided to correct each qualified sensing element.

5. The multi-sensing-elements calibration system according to claim 1, wherein the first sensing condition, the second sensing condition and the third sensing condition are conditions under which the sensing elements perform a sensing operation at different sensing time points.

6. The multi-sensing-elements calibration system according to claim 1, wherein the sensing elements are temperature sensing elements, and the first sensing condition, the second sensing condition and the third sensing condition are conditions under which a sensing operation is performed at different temperature values

7. The multi-sensing-elements calibration system according to claim 1, further comprising an information providing module, used for providing a reference curve, wherein the second calculating module, after generating the calibration curve for each sensing element, further selects one of the reference curve and the calibration curve of a specific sensing element according to a control instruction, and the selected one is provided to the specific sensing element to perform calibration.

8. The multi-sensing-elements calibration system according to claim 7, wherein the reference curve is generated according to sensing values of a standard sensing element under the first sensing condition, the second sensing condition and the third sensing condition, the first average value, the second average value and the third average value.

9. A multi-sensing-elements calibration method, comprising:
providing, by a plurality of sensing elements, a plurality of sensing values, wherein the sensing elements are configured at a same place, and each sensing element is separately used for generating a first sensing value under a first sensing condition, generating a second sensing value under a second sensing condition, and generating a third sensing value under a third sensing condition;
obtaining, by a first calculating module, a first average value according to the first sensing values generated by the sensing elements under the first sensing condition, obtaining a second average value according to second sensing values generated by the sensing elements under the second sensing condition, and obtaining a third average value according to third sensing values generated by the sensing elements under the third sensing condition; and
generating, by a second calculating module, a calibration curve for each sensing element according to the first sensing value, the second sensing value, and the third sensing value of each sensing element, the first average value, the second average value and the third average value.

10. The multi-sensing-elements calibration method according to claim 9, wherein the step of obtaining, by the first calculating module, the first average value according to the first sensing values generated by the sensing elements under the first sensing condition further comprises:
first averaging, by the first calculating module, the first sensing values to generate a first estimated value, selecting a plurality of specific first sensing values from the first sensing values, and obtaining the first average value by averaging the plurality of specific first sensing values, wherein a difference between each of the plurality of specific first sensing values and the first estimated value does not exceed a threshold value.

11. The multi-sensing-elements calibration method according to claim 10, wherein a sensing element with a sensing value, whose difference with the first estimated value does not exceed the threshold value, is a qualified sensing element, and the second calculating module generates a calibration curve for each qualified sensing element according to the first sensing value, the second sensing value, and the third sensing value of the qualified sensing element, the first average value, the second average value and the third average value, and the calibration curve is provided to correct each qualified sensing element.

12. The multi-sensing-elements calibration method according to claim 9, wherein the step of generating, by second calculating module, a calibration curve for each sensing element further comprises:
generating, by the second calculating module, a first calibration value, a second calibration value and a third calibration value for each sensing element according to the first sensing value, the second sensing value, and the third sensing value of each sensing element, the first average value, the second average value and the third average value; and
generating, by the second calculating module, a calibration curve for each sensing element according to the first calibration value, the second calibration value and the third calibration value of each sensing element, the first average value, the second average value and the third average value.

13. The multi-sensing-elements calibration method according to claim 9, wherein the first sensing condition, the second sensing condition and the third sensing condition are conditions under which the sensing elements perform a sensing operation at different sensing time points.

14. The multi-sensing-elements calibration method according to claim 9, wherein the sensing elements are temperature sensing elements, and the first sensing condition, the second sensing condition and the third sensing condition are conditions under which a sensing operation is performed at different temperature values.

15. The multi-sensing-elements calibration method according to claim 9, further comprising:
providing, by an information providing module, a reference curve; and
selecting, by the second calculating module, after generating the calibration curve for the sensing element, one of the reference curve and the calibration curve for a specific sensing element according to a control instruction, wherein the selected one is provided to the sensing element to perform calibration.

16. The multi-sensing-elements calibration method according to claim 15, wherein the reference curve is generated according to a first sensing value, a second sensing value and a third sensing value of a standard sensing element under the first sensing condition, the second sensing condition and the third sensing condition, and according to the first average value, the second average value and the third average value.

17. A non-immediately recording medium, storing a program code readable by an electronic apparatus, wherein when the electronic apparatus reads the program code, a multi-sensing-elements calibration method is executed, and the method comprises the following steps of:
providing, by a plurality of sensing elements, a plurality of sensing values, wherein the sensing elements are configured at a same place, and each sensing element is separately used for generating a first sensing value under a first sensing condition, generating a second sensing value under a second sensing condition, and generating a third sensing value under a third sensing condition;
obtaining, by a first calculating module, a first average value according to the first sensing values generated by the sensing elements under the first sensing condition, obtaining a second average value according to second sensing values generated by the sensing elements under the second sensing condition, and obtaining a third average value according to third sensing values generated by the sensing elements under the third sensing condition; and
generating, by a second calculating module, a calibration curve for each sensing element according to the first sensing value, the second sensing value, and the third sensing value of each sensing element, the first average value, the second average value and the third average value.
